(19) United States
(12) Patent Application Publication
(10) Pub. No.: US 2024/0149690 A1
(43) Pub. Date: May 9, 2024

(54) POWER DISTRIBUTION CONTROL APPARATUS AND VEHICLE HAVING THE SAME

(71) Applicants: HYUNDAI MOTOR COMPANY, Seoul (KR); KIA CORPORATION, Seoul (KR)

(72) Inventor: Un CHON, Seongnam-si (KR)

(73) Assignees: Hyundai Motor Company, Seoul (KR); KIA CORPORATION, Seoul (KR)

(21) Appl. No.: 18/231,956

(22) Filed: Aug. 9, 2023

(30) Foreign Application Priority Data
Nov. 3, 2022 (KR) 10-2022-0145356

(51) Int. Cl. B60L 1/00; B60H 1/00; B60L 58/18; B60L 58/25

(52) U.S. Cl. CPC B60L 1/00; B60H 1/00742; B60L 58/18; B60L 58/25

(57) ABSTRACT

A vehicle includes an input device, a first battery, a battery monitoring system configured to monitor a state of charge (SOC) value of the first battery, and a power distribution control apparatus configured to determine whether the vehicle is in a ready state based on an operating state of the driving motor when an On command for an Eco mode is received, obtain a driving-possible distance based on the SOC value of the first battery when it is determined that the vehicle is in the ready state, and control a power saving mode of the vehicle based on the obtained driving-possible distance, wherein electric power to be supplied to the first load is limited in the power saving mode. The power saving mode is a mode in which electric power to be supplied to the first load is limited.

### CROSS-REFERENCE TO RELATED APPLICATION

The present application claims priority to Korean Patent Application No. 10-2022-0145356, filed on Nov. 3, 2022, the entire contents of which is incorporated herein for all purposes by this reference.

### BACKGROUND OF THE PRESENT DISCLOSURE

### Field of the Present Disclosure

The present disclosure relates to a power distribution control apparatus for distributing and supplying electric power charged in first and second batteries to first and second loads based on a driving-possible distance, and a vehicle having the same.

### Description of Related Art

Vehicles may be classified into internal combustion engine vehicles and eco-friendly vehicles depending on power sources.

The eco-friendly vehicles may be classified into an electric vehicle including a battery which is a rechargeable power source and a driving motor to rotate the driving motor with electricity accumulated in the battery and drive wheels using the rotation of the driving motor, and a hybrid vehicle including an engine, a battery, and a driving motor to drive by controlling mechanical power of the engine and electric power of the driving motor.

The eco-friendly vehicle includes a first battery to supply electric power for starting and driving power, further includes various electronic components to protect occupants and provide convenience and fun to occupants, and further includes a second battery to supply electric power for driving to various electronic components (i.e., electronic devices).

The eco-friendly vehicle has a problem in that a driving-possible distance thereof is drastically reduced when an air-heated air conditioner (PTC heater) is used.

Furthermore, in the eco-friendly vehicle, when it is difficult for an eco-friendly vehicle to reach a destination with a current battery charge, that is, when the current battery charge is less than a charging amount required to reach the destination, an additional function other than driving, for example, an air conditioning function is directly lowered or turned off by a user. As a result, the eco-friendly vehicle includes a problem of poor driving environment in summer or winter, and includes a problem in that additional functions may be directly manipulated by the user in consideration of the remaining distance to the destination.

Furthermore, in the case of an eco-friendly vehicle with an Economical mode (Eco mode), when an SOC value of a high-voltage battery falls below about 10% while driving in the Eco mode, the eco-friendly vehicle automatically turns off the air-heated air conditioner to improve battery life and durability. In the instant case, the eco-friendly vehicle also includes a problem of poor driving environment in summer or winter.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a power distribution control apparatus configured for limiting electric power to be supplied to a first load when in an Eco mode and in an EV ready state, and a vehicle including the same.

It is another aspect of the present disclosure to provide a power distribution control apparatus configured for controlling preheating of a first battery based on a temperature of the first battery when in an OFF state and in a charging mode and controlling an automatic air conditioning mode based on whether a user is on board or not, and a vehicle having the same.

Additional aspects of the present disclosure will be set forth in part in the description which follows, and in part, will be obvious from the description, or may be learned by practice of the present disclosure.

In accordance with an aspect of the present disclosure, a distribution control apparatus includes a communication device configured to communicate with a battery monitoring system and an input device, and a processor communicatively connected to the communication device, configured to, when the processor receives an On command for an Eco mode through the input device and the processor concludes that a vehicle is in a ready state, obtain a driving-possible distance based on a state of charge (SOC) value of a first battery received through the battery monitoring system and control a power saving mode of the vehicle based on the obtained driving-possible distance. The processor, in response to the control of the power saving mode, may be configured for controlling an output of a first load in the vehicle so that an amount of electricity to be supplied to the first load from the first battery is reduced when controlling the power saving mode.

The processor is configured to determine whether the vehicle is in the ready state based on an operating state of a driving motor connected to a wheel in the vehicle.

The processor may release the power saving mode when an ON/OFF command for automatic air conditioning, an ON/OFF command for at least one heating wire, an ON/OFF command for an air circulation mode, or information on a target inside temperature is received through the input device.

The processor may release the power saving mode when the obtained driving-possible distance exceeds a first reference driving-possible distance.

The processor is configured to determine whether the obtained driving-possible distance is shorter than a second reference driving-possible distance when the processor concludes that the obtained driving-possible distance is shorter than or equal to the first reference driving-possible distance, and determine that a drive mode enters a first power saving mode when the processor concludes that the obtained driving-possible distance is shorter than the second reference driving-possible distance, and determine that the drive mode enters a second power saving mode when the processor concludes that the obtained driving-possible distance is longer than or equal to the second reference driving-possible distance. The first reference driving-possible distance may be longer than the second reference driving-possible distance.

The processor is configured to control may be configured for controlling the output of the first load to a first output amount when the drive mode enters the first power saving mode, and control the output of the first load to a second output amount lower than the first output amount when the drive mode enters the second power saving mode.

The processor may, when controlling the power saving mode, stop an operation of the first load and control an operation of a second load using electric power of a second battery. A voltage of the second battery may be lower than a voltage of the first battery.

The processor is configured to control may be configured for controlling to stop the operations of the first and second loads when the obtained driving-possible distance is shorter than a third reference driving-possible distance. The third reference driving-possible distance may be shorter than the second reference driving-possible distance.

The first load may include a driving motor, a heater for heating, and a heater for preheating of the first battery. The second load may include at least one heating wire and a blowing fan of an air conditioner.

The processor is configured to control may be configured for controlling an operation of the first load based on a temperature and the SOC value of the first battery when the vehicle is in an OFF state and in a charging mode.

In accordance with another aspect of the present disclosure, a vehicle includes an input device, a first battery configured to supply electric power to a driving motor and a first load, a battery monitoring system configured to monitor a state of charge (SOC) value of the first battery, and a power distribution control apparatus configured to determine whether the vehicle is in a ready state based on an operating state of the driving motor when an On command for an Eco mode is received through the input device, obtain a driving-possible distance based on the SOC value of the first battery when it is determined that the vehicle is in the ready state, and control a power saving mode of the vehicle based on the obtained driving-possible distance, wherein electric power to be supplied to the first load is limited in the power saving mode. The power saving mode may be a mode in which electric power to be supplied to the first load is limited.

The power distribution control apparatus may release the power saving mode when an ON/OFF command for automatic air conditioning, an ON/OFF command for at least one heating wire, an ON/OFF command for an air circulation mode, or information on a target inside temperature is received through the input device.

The power distribution control apparatus may release the power saving mode when the obtained driving-possible distance exceeds a first reference driving-possible distance.

The power distribution control apparatus may be configured to determine whether the obtained driving-possible distance is shorter than a second reference driving-possible distance when the processor concludes that the obtained driving-possible distance is shorter than or equal to the first reference driving-possible distance, determine that a drive mode enters a first power saving mode when the processor concludes that the obtained driving-possible distance is shorter than the second reference driving-possible distance, and determine that the drive mode enters a second power saving mode when the processor concludes that the obtained driving-possible distance is longer than or equal to the second reference driving-possible distance. The first reference driving-possible distance may be longer than the second reference driving-possible distance.

The power distribution control apparatus may be configured for controlling the output of the first load to a first output amount when the drive mode enters the first power saving mode, and control the output of the first load to a second output amount lower than the first output amount when the drive mode enters the second power saving mode.

The vehicle may further include an electric power converter provided to convert a voltage of electric power output from the first battery into a voltage of a different magnitude, and a second battery provided to perform charging using the voltage converted by the electric power converter and to supply electric power to a second load.

The power distribution control apparatus may, when controlling the power saving mode, stop an operation of the first load and control an operation of a second load using electric power of the second battery.

The power distribution control apparatus may be configured for controlling to stop the operations of the first and second loads when the obtained driving-possible distance is shorter than a third reference driving-possible distance, and control an operation of the driving motor based on a preset torque map of the driving motor.

The first load may include the driving motor, a heater for heating, and a heater for preheating of the first battery. The second load may include at least one heating wire and a blowing fan of an air conditioner.

The battery monitoring system may include a temperature sensor provided to detect a temperature of the first battery. The power distribution control apparatus may be configured for controlling the operation of the first load based on the temperature of the first battery detected by the temperature sensor and the SOC value of the first battery when the vehicle is in an OFF state and in a charging mode.

The vehicle may further include a boarding detector provided to detect boarding of a user. The power distribution control apparatus may activate an automatic air conditioning mode based on the temperature of the first battery and boarding information detected by the boarding detector.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an exemplary internal view of a vehicle body according to an exemplary embodiment of the present disclosure;

FIG. 2 is an exemplary diagram of an electric power supply line of the vehicle according to an exemplary embodiment of the present disclosure;

FIG. 3 is a control schematic diagram of the vehicle according to an exemplary embodiment of the present disclosure;

FIG. 4 is a control schematic diagram of a power distribution control apparatus of the vehicle according to an exemplary embodiment of the present disclosure;

FIG. 5 is an exemplary diagram of a power saving mode for each driving-possible distance of the vehicle according to an exemplary embodiment of the present disclosure;

FIG. 6A and FIG. 6B are a control flowchart of the vehicle according to an exemplary embodiment of the present disclosure;

FIG. 7 and FIG. 8 are exemplary display views of a terminal provided in the vehicle according to an exemplary embodiment of the present disclosure;

FIG. 9 is a flowchart of a cooperative control during execution of the power saving mode of the vehicle according to an exemplary embodiment of the present disclosure; and

FIG. 10A and FIG. 10B are a control flowchart in a charging mode of the vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Throughout the specification, like reference numerals refer to like components. The present specification does not describe all factors of embodiments, and duplicative contents between general contents or embodiments in the technical field of the present disclosure will be omitted. The terms ‘part,’ ‘module,’ ‘member,’ and ‘device’ used in the present specification may be embodied as software or hardware, and it is also possible for a plurality of ‘parts,’ ‘modules,’ ‘members,’ and ‘devices’ to be embodied as one component, or one part,’ ‘module,’ ‘member,’ and ‘device’ to include a plurality of components according to the embodiments.

Throughout the specification, when a part is referred to as being “connected” to another part, it includes not only a direct connection but also an indirect connection, and the indirect connection includes connecting through a wireless network.

When it is described that a part “includes” a component, it means that the may further include other components, not excluding the other components unless specifically stated otherwise.

Throughout the specification, when a component is referred to as being located “on” or “over” another component, this includes not only a case in which a component is in contact with another component but also a case in which another component exists between the two components.

The terms ‘first,’ ‘second,’ etc. are used to distinguish one component from another component, and the components are not limited by the above-mentioned terms.

The singular forms “a,” “an,” and “the” include plural referents unless the context clearly dictates otherwise.

In each step, an identification numeral is used for convenience of explanation, the identification numeral does not describe the order of the steps, and each step may be performed differently from the order specified unless the context clearly states a particular order.

Hereinafter, an operation principle and embodiments of the present disclosure will be described with reference to the accompanying drawings.

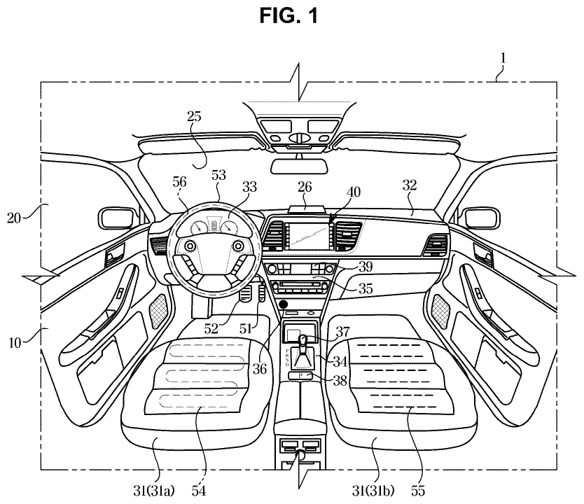

FIG. 1 is an exemplary internal view of a vehicle body according to an exemplary embodiment of the present disclosure.

A vehicle according to the exemplary embodiment of the present disclosure may be an eco-friendly vehicle driven by electricity as power to reduce fuel consumption and emission of harmful gases.

The eco-friendly vehicle may be one of an electric vehicle including a first battery which is a rechargeable power source and a driving motor to rotate the driving motor with electricity accumulated in the first battery and drive wheels using the rotation of the driving motor, a hybrid vehicle including an engine, a battery, and a driving motor to drive by controlling mechanical power of the engine and electric power of the driving motor, and a hydrogen fuel cell vehicle.

In the exemplary embodiment of the present disclosure, an electric vehicle among eco-friendly vehicles will be referred to as an example.

A vehicle 1 includes a body including an exterior and an interior, and a chassis supporting the body and on which mechanical devices required for driving are provided as remaining portions except for the body.

The exterior of the body includes a front panel, a bonnet, a roof panel, a rear panel, front, rear, left and right doors 10, and window glasses 20 provided to be configured to be opened or closed on the front, rear, left and right doors 10.

The exterior of the body may further include a front wind shield glass 25 and a rear wind shield glass.

A glass heater 26 may be provided around the front wind shield glass 25 as a heater for removing frost formed on the front wind shield glass 25.

A defrost heater may also be provided around the rear windshield glass to remove frost formed on the rear windshield glass.

The exterior of the body also includes side mirrors providing a driver with a view of the rear of the vehicle 1, and lamps helping the driver easily recognize surrounding information while looking at a front view and performing the functions of signals and communication for other vehicles and pedestrians.

As illustrated in FIG. 1, the interior of the body includes seats 31 (31a and 31b) on which an occupant sits, a dashboard 32, a cluster 33, a center fascia 34 in which air outlets and adjusting plates of an air conditioner are disposed, a head unit 35 provided on the center fascia to receive operation commands for an audio device and the air conditioner, and a start button 36 (or referred to as a boot button) provided on the center fascia to receive a start command.

The seat 31 includes the driver seat 31a on which a user sits, and the front occupant seat 31b on which an occupant sits, and may further include a rear seat on which another occupant other than the driver and the occupant sits.

The cluster 33 may include a display panel, and may display state information of the first battery and a second battery and information on a drive mode in response to a control command of a power distribution control apparatus 130.

The vehicle 1 further includes a shift lever 37 provided on the center fascia 34 to receive an input of an operation position, and a parking button (EPB button) 38 located around the shift lever 37 or on the head unit 35 to receive an operation command for an electronic parking brake device.

The vehicle 1 further includes an Audio, Video and Navigation (AVN) device 40 (or referred to as a vehicle terminal) for user convenience. The AVN device 40 may be provided by being embedded in or mounted on the dashboard 32.

The vehicle 1 includes an accelerator pedal 51 provided to be pressed by the user according to an acceleration intention of the user, a brake pedal 52 provided to be pressed by the user according to a braking intention of the user, and a steering wheel 53 of a steering device provided to adjust a driving direction thereof.

The vehicle 1 may further include a seat heating wire 54 provided in the seat 31, may further include a seat ventilator 55 provided in the seat 31, and may further include a steering heating wire 56 provided in the steering wheel 53.

The seat heating wire 54 may be provided only in the driver seat 31a, only in the driver seat 31a and front occupant seat 31b, or in all of the driver seat 31a, front occupant seat 31b, and rear seat. That is, at least one of the seat heating wires 54 may be provided.

The seat ventilator 55 may be provided only in the driver seat 31a, only in the driver seat 31a and front occupant seat 31b, or in all of the driver seat 31a, front occupant seat 31b, and rear seat. That is, at least one of the seat ventilators 55 may be provided.

The chassis may be provided with wheels 60 disposed on front, rear, left and right sides of the vehicle 1, respectively, a power unit provided to apply a driving force to the front, rear, left and right wheels 60, the steering device, a braking device provided to apply a braking force to the front, rear, left and right wheels 60, and a suspension device.

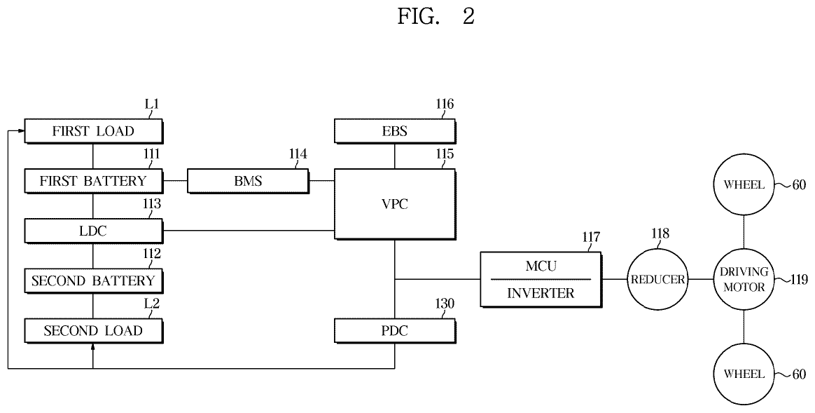

FIG. 2 is an exemplary diagram of an electric power supply line of the vehicle according to an exemplary embodiment of the present disclosure.

The vehicle may include a power supply, the power unit provided to receive electric power from the power supply to generate a driving force necessary for driving of the vehicle and adjust the generated driving force, and a plurality of loads provided to perform various convenience and safety functions by receiving electric power from the power supply.

The power supply may supply electric power to the power unit and various loads other than the power unit.

The power supply may supply electric power to a vehicle platform controller 115 for control functions such as driving and braking of the vehicle and the power distribution control apparatus 130 for a power distribution control function.

The power supply may include the first battery 111, the second battery 112, an electric power converter 113 and a battery monitoring system 114.

The first battery 111 may include a plurality of battery cells to generate high-voltage electric power to apply the driving force to the vehicle.

The first battery 111 may include a plurality of battery modules. Each of the battery modules may include a plurality of battery cells connected in series and parallel.

These battery cells may be gathered to form a battery module, and battery modules may be gathered to form a battery pack.

The first battery 111 may be configured for charging thereof and discharging therefrom.

The first battery 111 may be charged by receiving external power, and may be charged using electric power generated during regenerative braking.

The first battery 111 may supply electric power to a driving motor 119 and a first load L1 consuming high voltage electric power, and may supply electric power to the second battery 112.

The first load L1, which is a high voltage load, may include a compressor of the air conditioner or at least one heater. The at least one heater may include a first heater for heating the internal and a second heater for preheating the first battery 111.

The high voltage load may be a load that receives a voltage higher than a preset voltage and operates using the applied voltage.

The second battery 112 may be configured for being charged thereof and discharged therefrom.

The second battery 112 may be charged using electric power charged in the first battery 111.

The second battery 112 may supply electric power to a second load L2 receiving a lower voltage than the voltage applied to the first load L1.

The second battery 112 may supply electric power to the second load L2 regardless of starting ON/OFF of the vehicle.

The second load L2 may be a low voltage load.

The low voltage load may be a load that receives a voltage lower than a preset voltage and operates using the applied voltage.

For example, the second load L2 may include electronic components such as convenience devices and additional devices.

The second load L2 may include the terminal 40, at least one of the seat heating wires 54, the steering heating wire 56, and the glass heater 26 (heater for removing frost).

The second load L2 may further include the seat ventilator 55.

The second load L2 may further include basic loads essential to the vehicle, such as lamps.

A switch IBS may be provided in the second battery 112. This switch may be connected to the power distribution control apparatus 130, and may be turned on or turned off by the control of the power distribution control apparatus 130.

The electric power converter 113 converts the DC electric power of the first battery 111 into DC electric power suitable for charging the second battery 112 and supplies the converted DC electric power to the second battery 112, so that the second battery 112 may be charged.

The electric power converter 113 may lower the voltage output from the first battery 111 to a certain magnitude and apply the lowered voltage to the second battery 112.

The electric power converter 113 may include at least one switch element and an inductor.

The electric power converter 113 may directly supply the converted DC electric power to the second load L2.

The battery monitoring system 114 may monitor the first battery 111.

The battery monitoring system 114 may also monitor the second battery 112.

The battery monitoring system (BMS) 114 may include a plurality of sensors to collect information related to a state of the first battery 111, such as an output voltage of the first battery 111, an input/output current of the first battery 111, and a temperature of the first battery 111.

The plurality of sensors may include a current sensor configured for detecting a current of the first battery 111, a voltage sensor configured for detecting a voltage at an output end of the first battery 111, and a temperature sensor configured for detecting a temperature of the first battery 111.

The battery monitoring system 114 may obtain a state of charge (SOC) value of the first battery corresponding to a current, voltage, and temperature of each battery cell from a pre-stored table. A charge amount of the first battery 111 corresponding to a correlation between the current, voltage, and temperature of the battery cells may be matched to the pre-stored table.

The battery monitoring system 114 is configured to determine and manages a state of charge (SOC) value of the first battery 111 and a state of health (SoH) of the first battery 111 based on the information related to the state of the first battery 111.

The battery monitoring system 114 as described above monitors the SOC value of the first battery 111, may transmit information on the state of charge (SOC) value of the first battery 111 to the vehicle platform controller 115 and may also transmit it to the power distribution control apparatus 130.

The battery monitoring system 114 may obtain available electric power information of the first battery III and transmit the obtained available electric power information of the first battery 111 to the vehicle platform controller 115.

The battery monitoring system 114 may also transmit the obtained available electric power information of the first battery 111 to the power distribution control apparatus 130.

The battery monitoring system 114 may transmit temperature information of the first battery 111 to at least one of the vehicle platform controller 115 and the power distribution control apparatus 130.

The battery monitoring system 114 may obtain a torque command of the driving motor 119 from the vehicle platform controller 115 by transmitting the available electric power information of the first battery 111 and the state of charge (SoC) information of the first battery 111 to the vehicle platform controller 115.

That is, the vehicle may include the vehicle platform controller 115 to control the driving, braking, and steering of the vehicle.

The vehicle platform controller 115 obtains the torque command of the driving motor 119 based on the available electric power information of the first battery 111, available torque information of the driving motor 119, a braking amount requested by the driver, an acceleration amount requested by the driver, and driving speed information of the vehicle.

The vehicle may further include a speed sensor to detect a driving speed of the vehicle. The speed sensor may include at least one of a plurality of wheel speed sensors and acceleration sensors.

The vehicle platform controller 115 may obtain a charging torque command of the driving motor 119 for regenerative braking based on a required amount of regenerative braking, the available electric power information of the first battery 111 and the available torque information of the driving motor 119, and may obtain a needed amount of regenerative braking based on the obtained charging torque command of the driving motor 119 and an actual output torque of the driving motor 119 transmitted from a motor controller unit.

The vehicle platform controller 115 may obtain driving-possible distance information (DTE) based on the state of charge (i.e., charge amount) (SOC) information of the first battery, the available electric power information of the first battery, and pre-stored power consumption information, and transmit the obtained driving-possible distance information to the power distribution control apparatus 130.

The vehicle platform controller 115 may receive the pre-stored power consumption information from the vehicle terminal 40.

The vehicle platform controller 115 may obtain an allowable electric power amount which may be supplied to the second load L2 based on the state of charge (i.e., charge amount) (SOC) information of the first battery, the driving-possible distance information, and remaining distance information, and transmit the obtained allowable electric power amount to the electric power distribution control apparatus 130.

The vehicle platform controller 115 may check an operating state of the driving motor 119, determine whether the vehicle is in a ready state based on the checked operating state of the driving motor 119, and transmit the determined state information of the vehicle to the power distribution control apparatus 130 when it is determined that the vehicle is in the ready state.

Herein, the ready state may be a ready state (EV ready state) for an electric vehicle drive mode.

The vehicle platform controller 115 may be configured to determine whether the vehicle is in the ready state based on an actual torque of the driving motor 119.

The vehicle platform controller 115 may be configured to determine whether the vehicle is in the ready state based on a rotation speed of the driving motor 119. The rotation speed of the driving motor 119 may be obtained from information detected by the speed sensor.

The vehicle may further include an electronic brake system (EBS) 116.

The electronic brake system 116 obtains a braking amount required by the driver corresponding to a braking requirement of the driver received from a brake position sensor (BPS), and distributes the obtained braking amount required by the driver into a hydraulic braking amount and a regenerative braking amount.

The electronic brake system 116 may correct the hydraulic braking amount based on the needed amount of regenerative braking obtained from the vehicle platform controller 115.

Herein, the regenerative braking refers to operating the driving motor 119 as a generator during deceleration or braking, converting kinetic energy of the vehicle into electrical energy, and charging the first battery 1 using the converted electrical energy.

The power unit may include an inverter 117, a reducer 118 and the driving motor 119, and may further include a motor control unit (MCU) for controlling the driving motor 119.

The motor control unit (MCU) transmits an available torque of the driving motor 119 to the vehicle platform controller 115. Through this, the motor control unit (MCU) may obtain the torque command of the driving motor 119 from the vehicle platform controller 115.

The inverter 117 converts a DC voltage into an AC voltage and applies the converted AC voltage to the driving motor 117. That is, the inverter 117 may convert electric power of the first battery 110 into driving electric power of the driving motor 119.

The inverter 117 transmits the available torque of the driving motor 119 and the actual torque of the driving motor 119 to the vehicle platform controller 115.

The motor controller unit (MCU) receives the torque command of the driving motor 119 from the vehicle platform controller 115, generates a pulse width modulation signal based on the received torque command of the driving motor 119, and is configured to control an operation of the inverter 117 based on the generated pulse width modulation signal.

The inverter 117 generates electric power for driving the driving motor 119 by performing a turn-On/Off operation in response to the pulse width modulation signal (PWM) of the motor controller unit (MCU) and converts the generated electric power to the driving motor 119.

The electric power generated by the inverter 117 may vary depending on a switching signal for outputting a current corresponding to the driving speed of the vehicle and a switching signal for outputting a voltage corresponding to the driving speed of the vehicle.

The driving speed of the vehicle may be a driving speed set by the user, a driving speed reflecting a braking intention of the user, or a driving speed reflecting an acceleration intention of the user.

The inverter 117 may also transmit electric power generated by the driving motor 119 to the first battery 111 during regenerative braking. That is, the inverter 117 may include a plurality of switch elements and may perform a function of changing a direction and output of current between the driving motor 119 and the first battery 111.

The reducer 118 transmits a rotation force generated by reducing the speed of the driving motor 119 and increasing the torque of the driving motor 119 to the wheels 60.

The driving motor 119 generates a rotation force using electrical energy of the first battery 111 and transmits the generated rotation force to the wheels 60 so that the wheels 60 are driven.

When the start button 36 is turned on, the maximum current is supplied to the driving motor 119 to generate the maximum torque.

The driving motor 119 operates as a generator to charge the first battery 111 under energy regeneration conditions such as braking, deceleration, steel plate driving, and low speed (i.e., a speed lower than a predetermined speed) driving.

The power supply of the vehicle may further include a charge controller 120 to which a fast charging cable or a slow charging cable are connected and controlling reception of electric power for charging the first battery 111.

The charge controller 120 may include a quick charger for rapidly charging the first battery 111, and a slow charger for charging the first battery 111 at a slow rate, which is slower than a rate for rapid charging.

The charge controller 120 (OBC: on board charger) converts an external commercial power (AC) supplied from the slow charger into a rectified and direct current, and transfers the converted direct current to the first battery 111. The charge controller 120 may include an AC rectifier, a power factor correction (PFC), a converter, and a capacitor.

The power distribution control apparatus 130 may distribute electric power of the first battery 111 and supply the distributed electric power to the driving motor 119, the electric power converter 113, and the first load L1.

The power distribution control apparatus 130 may manage electric power of the second battery 112 to supply the electric power of the second battery 112 to the second load L2.

When the vehicle is in an Eco mode and is in the ready state, the power distribution control apparatus 130 may obtain a driving-possible distance based on the SOC value of the first battery and control a power saving mode of the vehicle based on the obtained driving-possible distance.

When the vehicle is in the Eco mode and is in the ready state, the power distribution control apparatus 130 is configured to perform the power saving mode by limiting the electric power to be distributed to the first load, and is configured to control the operation of the second load by supplying electric power from the second battery to the second load based on the state of charge information of the first battery and an inside temperature detected by an inside temperature sensor to compensate for the output degradation of the first load.

The power distribution control apparatus 130 may release the power saving mode when a user input for controlling the operation of the air conditioner or heating wires is received while the Eco mode is being executed.

That is, the user input may include an ON/OFF command for the automatic air conditioning mode, an ON/OFF command for the automatic heating wire mode for at least one of the heating wires, an ON/OFF command for the inside air circulation mode, an ON/OFF command for the outside air circulation mode, control information of a target temperature of at least one of the heating wires, and control information of a target inside temperature.

When the vehicle is in an OFF state and in the Eco mode and a charging mode, the power distribution control apparatus 130 may be configured for controlling preheating of the first battery based on the state of charge information of the first battery 111 and the temperature information of the first battery 111, and may be configured for controlling activation of the automatic air conditioning mode based on the temperature information of the first battery III and boarding information of the user.

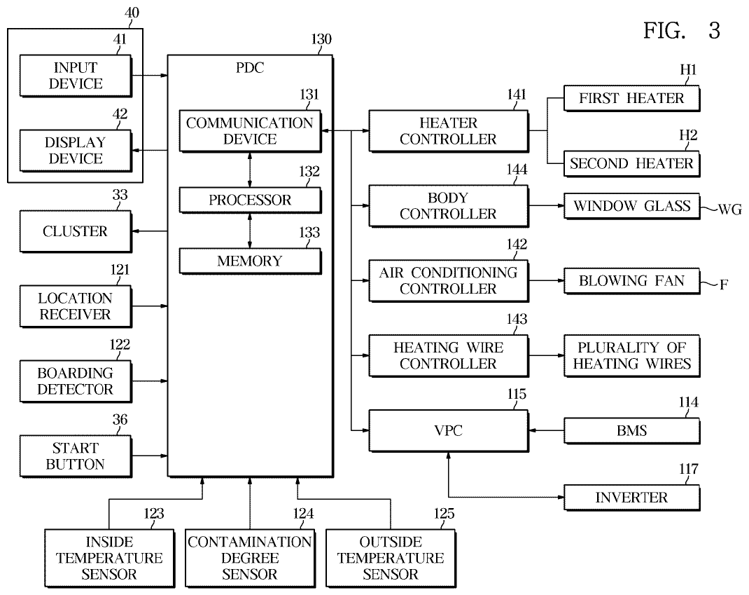

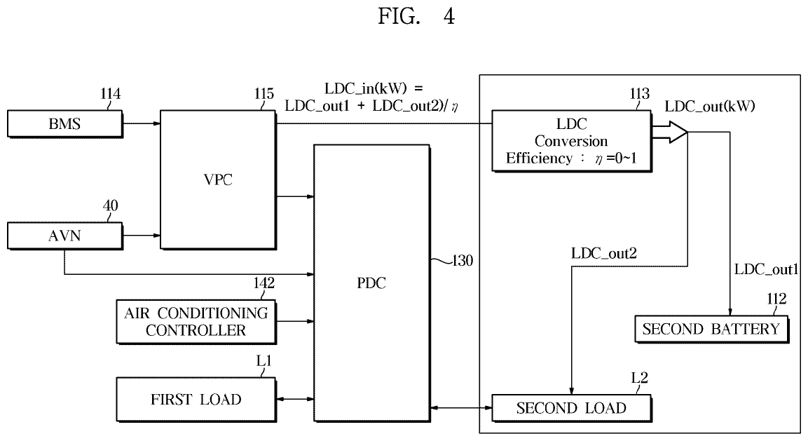

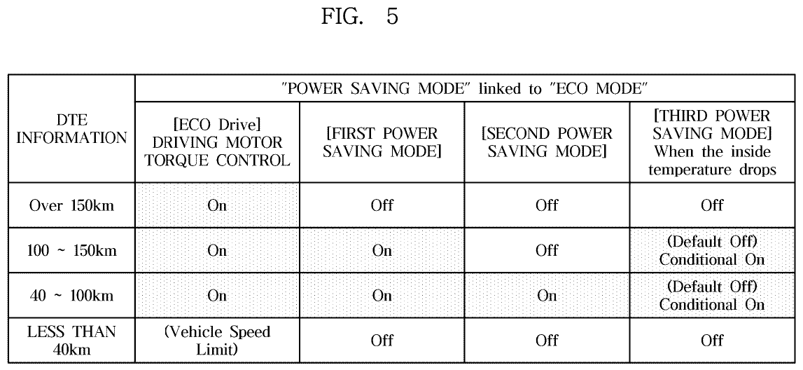

The configuration of the power distribution control apparatus 130 as described above will be described below with reference to FIG. 3, FIG. 4, and FIG. 5.

FIG. 3 is a control schematic diagram of the vehicle according to an exemplary embodiment of the present disclosure, FIG. 4 is a control schematic diagram of a power distribution control apparatus of the vehicle according to an exemplary embodiment of the present disclosure, and FIG. 5 is an exemplary diagram of a power saving mode for each driving-possible distance of the vehicle according to an exemplary embodiment of the present disclosure.

The vehicle 1 includes the cluster 33, the start button 36, the AVN device 40 (or referred to as a vehicle terminal), the battery monitoring system 114, the vehicle platform controller 115, the inverter 117, a location receiver 121, a boarding detector 122, an inside temperature sensor 123, a contamination degree sensor 124, the electric power distribution control apparatus 130, a heater controller 141, an air conditioning controller 142, a heating wire controller 143, and a body controller 144.

The vehicle 1 may include various electronic components for the control of the vehicle 1 and the safety and convenience of the occupants, as well as the mechanical components described above.

For example, the electronic components may include first and second heaters H1 and H2, a heating/ventilation/air conditioner (HVAC) for controlling the inflow of air from the outside of the vehicle 1 or heating or cooling the inside air depending on an inside temperature of the vehicle 1, a plurality of heating wires, a ventilator of the seat, window glasses (WG), a sunroof, wipers, internal lamps, and an electric power tailgate.

The plurality of heating wires may include a steering heating wire, a glass heating wire, and at least one seat heating wire.

The air conditioner (heating/ventilation/air conditioning, HVAC) may include a blowing fan F for blowing and may include a full automatic temperature controller (FATC) for controlling in the automatic air conditioning mode.

The various electronic components may be loads that perform predetermined functions while receiving electric power and consuming the received electric power.

The electronic components may communicate with each other through an in-vehicle communication network NT. For example, the electronic components may transmit and receive data through a communication network such as an Ethernet, a Media Oriented Systems Transport (MOST), Flexray, a Controller Area Network (CAN), and a Local Interconnect Network (LIN).

The cluster 33 may display information related to driving of the vehicle and information related to the state of the vehicle.

For example, the cluster 33 may display a drive mode of the vehicle and state information of the vehicle.

The drive mode of the vehicle may include a sports drive mode, a comfort drive mode, and the Eco mode.

The state information of the vehicle may include the ready state (EV_Ready), the OFF state (Off), and the charging mode.

The ready state is a state in which electric power is supplied to the driving motor 119 and various loads in the vehicle such as the first and second loads L1 and L2, is a ready state (EV_Ready state) for driving in an electric vehicle drive mode, and is a state in which the driving motor 119 is not operating.

The OFF state is a mode in which supply of electric power to the first battery 111 is cut off and a dark current is applied to predetermined electronic components through the second battery 112.

The OFF state may be a state in which the vehicle is parked.

The start button 36 receives the user input.

The start button 36 may be operated by the user. The start button 36 may receive a start-On command and a start-Off command as the user input, and may transmit a start-on signal corresponding to the received start-On command and a start-off signal corresponding to the start-Off command to the power distribution control apparatus 130.

The vehicle terminal (AVN device) 40 displays information related to functions currently operating in the vehicle 1 or functions operable in the vehicle 1, and also displays information input by the user.

For example, the vehicle terminal 40 may perform at least one of a navigation function, a broadcasting function, an audio function, a video function, a phone call function, a radio function, and an Internet function.

The vehicle terminal 40 may perform at least one function selected by the user.

When destination information is received, the vehicle terminal 40 checks current location information, searches for a plurality of routes from a current location to a destination based on the checked current location information and destination information, generates navigation information based on a route selected by the user among the plurality of searched routes, and is configured to control road guidance based on the generated navigation information.

The navigation information may include map information in which route information and road information are matched, and may further include distance information to the destination, information on a travel time to the destination and information on an arrival time at the destination.

The navigation information may further include driving-possible distance information.

The vehicle terminal 40 may obtain remaining distance information based on the current location information and the destination information, and transmit the obtained remaining distance information to the power distribution control apparatus 130.

The vehicle terminal 40 may transmit pre-stored power consumption to the vehicle platform controller.

The vehicle terminal 40 may transmit the pre-stored power consumption information for each section to the vehicle platform controller.

The section may be divided by a preset distance for each area.

The vehicle terminal 40 may output the remaining distance information and remaining time information to the destination while the vehicle is driving.

The vehicle terminal 40 may also display a user input for the drive mode and information on the drive mode.

The vehicle terminal 40 may be configured to determine whether it is an outside air circulation mode or an inside air circulation mode, output information on the determined circulation mode, and output outside air temperature information related to an outside temperature detected by an outside temperature sensor 125 or an outside temperature transmitted from the server.

The vehicle terminal 40 may output guidance information for guiding outside air circulation when a preset time elapses in a state in which the outside air circulation mode is turned off.

The vehicle terminal 40 may check a contamination degree of the interior of the vehicle detected by the contamination degree sensor 124 when the outside air circulation mode is turned off, and output the guidance information for guiding outside air circulation when the checked contamination degree is greater than or equal to a reference contamination degree.

When the drive mode is switched from the Eco mode to the power saving mode, the vehicle terminal 40 may output guidance information on switching to the power saving mode and operation information of various loads changed by the power saving mode.

The vehicle terminal 40 may also display the charge amount of the first battery and the driving-possible distance (DTE).

The vehicle terminal 40 may include a display device 42, and may further include an input device 41.

When both the display device 42 and the input device 41 are provided in the vehicle terminal 40, the vehicle terminal 40 may be a touch screen in which the input device 41 and the display device 42 are integrally provided.

When only the display device 42 is provided in the vehicle terminal 40, the input device for a display command of the display device 42 may be provided on the head unit or center fascia of the vehicle 1.

In the instant case, the input device may be provided as at least one of a button, a switch, a key, a touch panel, a jog dial, a pedal, a keyboard, a mouse, a track-ball, various levers, and a handle or stick.

In the exemplary embodiment of the present disclosure, the vehicle terminal 40 in which the input device 41 and the display device 42 are integrally provided will be described.

The input device 41 of the vehicle terminal 40 may receive the user input.

The input device 41 receives the drive mode, may receive the ON/OFF command for the outside air circulation mode and the ON/OFF command for the inside air circulation mode, and may receive an ON/OFF command for at least one of the heating wires and an ON/OFF command for at least one of the seat ventilators.

For example, the input device 41 may receive an On command and an Off command for a plurality of seat heating wires, and may receive a turn-On command and an Off command for at least one of the steering heating wire and the glass heating wire.

The input device 41 may receive the ON/OFF command for the automatic air conditioning mode and the ON/OFF command for the automatic heating wire mode, may receive the target inside temperature, and may receive a temperature level of at least one of the heating wires.

The input device 41 may receive the destination information and receive any one of the plurality of routes.

The display device 42 may display information received through the input device 41 and information related to functions of being operated in the vehicle.

The display device 42 may display the current drive mode.

The display device 42 may display the charge amount of the first and second batteries and the driving-possible distance, may display the drive mode, and may display the state of the vehicle.

The state of the vehicle may include the ready state, the electric vehicle driving state, and the OFF state.

The vehicle may further include a speaker for outputting sound.

The vehicle may output guidance information related to the drive mode and functions of being performed in the vehicle as sound or voice.

One or more of the speakers may be provided, may be provided in the vehicle terminal, or may be provided in the interior of the vehicle.

Because the battery monitoring system 114, the vehicle platform controller 115, and the inverter 117 have been described with reference to FIG. 2, descriptions thereof are omitted.

The location receiver 121 may include a Global Positioning System (GPS) receiver to communicate with a plurality of satellites.

The location receiver 121 may recognize a current location of the vehicle based on signals received from the plurality of satellites.

The location receiver 121 may transmit location information related to the current location of the vehicle to the terminal 40.

The boarding detector 122 detects whether or not the user has boarded the vehicle.

The boarding detector 122 may detect occupants accommodated on each seat and output detected occupant information to recognize boarding status and the number of occupants.

The boarding detector 122 may be provided on each seat and each seat belt of the vehicle.

For example, the boarding detector 122 may include at least one of a weight sensor, a pressure sensor, a capacitance sensor, and a seat belt fastening sensor.

The boarding detector 122 may include a camera provided inside the vehicle.

The boarding detector 122 may be provided in each door, detect an open state and a closed state of each door, and transmit an open signal corresponding to the open state and a close signal corresponding to the closed state to the power distribution control apparatus 130.

The inside temperature sensor 123 detects a temperature inside the vehicle.

The contamination degree sensor 124 detects the contamination degree of air inside the vehicle.

The outside temperature sensor 125 detects an air temperature outside the vehicle.

The heater controller 141 is configured to control an operation of the first heater H1 for heating the interior of the vehicle, and is configured to control an operation of the second heater H2 for preheating the first battery.

The heater controller 141 may transmit operation information of the first heater H1 and operation information of the second heater H2 to the power distribution control apparatus 130.

The operation information of the first heater H1 may include information on an amount of electricity consumed by operation of the first heater H1, and the operation information of the second heater H2 may include information on an amount of electricity consumed by operation of the second heater H2.

The heater controller 141 may be configured for controlling the operations of the first heater H1 and the second heater H2 based on a control command from the power distribution control apparatus 130.

The power distribution control apparatus 130 may transmit information on an amount of electricity consumable for the operation of the first heater H1 and information on an amount of electricity consumable for the operation of the second heater H2 to the heater controller 141.

The air conditioning controller 142 may be configured for controlling an operation of the blowing fan F provided in the air conditioner.

The air conditioning controller 142 may be configured for controlling an air blowing volume of the blowing fan F.

The air conditioning controller 142 may be configured for controlling the inside air circulation mode or the outside air circulation mode.

The air conditioning controller 142 may be the fully automatic temperature controller (FATC).

The air conditioning controller 142 may transmit information on an amount of electricity consumed by operation of the blowing fan to the power distribution control apparatus 130.

The air conditioning controller 142 may receive information on an amount of electricity consumable for the operation of the blowing fan from the power distribution control apparatus 130 and control the operation of the blowing fan based on the information on the amount of the receive consumable electric power.

The heating wire controller 143 may be configured for controlling turning on or off of one or more heating wires.

The heating wire controller 143 may transmit operation information of one or more heating wires to the power distribution control apparatus 130.

The operation information of the one or more heating wires may include information on an amount of electricity consumed by the operations of the one or more heating wires.

The heating wire controller 143 may be configured for controlling the operation of the one or more heating wires based on the control command transmitted from the power distribution control apparatus 130.

The heating wire controller 143 may receive information on an amount of electricity consumable for the operations of the one or more heating wires from the power distribution control apparatus 130, and control the operation of the one or more heating wires based on the received information on the amount of electricity.

The body controller 144 may be configured for controlling opening and closing of the one or more window glasses WG and opening and closing of the sunroof.

The body controller 144 may transmit information on an amount of electricity consumed by the opening and closing of the one or more window glasses WG to the power distribution control apparatus 130, and transmit information on an amount of electricity consumed by the opening and closing of the sunroof to the power distribution control apparatus 130.

The body controller 144 may receive information on an amount of electricity consumable through the opening and closing operations of the one or more window glasses WG from the power distribution control apparatus 130, and may receive information on an amount of electricity consumable through the opening and closing operation of the sunroof from the power distribution control apparatus 130.

The body controller 144 may be configured for controlling the opening and closing operations of the one or more window glasses WG based on the information on the amount of consumable electricity of the one or more window glasses WG received from the power distribution control apparatus 130.

The body controller 144 may be configured for controlling the opening and closing operation of the sunroof based on the information on the amount of consumable electricity of the sunroof received from the power distribution control apparatus 130.

As illustrated in FIG. 3 and FIG. 4, the power distribution control apparatus 130 may perform a cooperative control with at least one of a plurality of controllers and may also perform a cooperative control with the battery monitoring system 114.

As illustrated in FIG. 4, the power distribution control apparatus 130 may receive information related to the state of the vehicle and the driving-possible distance from the vehicle platform controller 115 and receive information related to the allowable electric power of the second battery.

The vehicle platform controller 115 may be configured to determine that the vehicle is in the ready state when an On command for the start button is received and a signal from the brake pedal is received. The signal from the brake pedal may include a pedal pressure signal.

The vehicle platform controller 115 may receive the charge state information and temperature information of the first battery 111 from the battery monitoring system 114 and receive the power consumption information from the terminal 40.

The vehicle platform controller 115 may obtain information on the driving-possible distance based on the received charge state information of the first battery 111 and the received power consumption information, and transmit information related to the obtained driving-possible distance to the power distribution control apparatus 130.

The vehicle platform controller 115 may receive allowable electric power information of the second load L2 from the electric power converter 113 based on output (LDC_in (kW)) of the electric power converter 113, and transmit the received allowable electric power information of the second load L2 to the power distribution control apparatus 130. Herein, the second load may be a load for air conditioning among the low voltage loads.

The electric power converter 113 may reduce the voltage output from the first battery 111 to a certain magnitude of voltage, and then transfer the reduced voltage electric power to the second battery 112 and the second load L2.

The electric power converter 113 may obtain electric power to be supplied to the second battery 112 and electric power to be supplied to the second load L2, obtain the total electric power supplied by adding the electric power to be supplied to the second battery 112 and the electric power to be supplied to the second load L2, obtain the output of the electric power converter 113 based on the obtained total supplied electric power and a preset conversion efficiency η, and transmit the obtained output (LDC_in(kW)) of the electric power converter 113 to the vehicle platform controller 115.

The power distribution control apparatus 130 is configured to determine whether the Eco mode is received through the input device 41 and checks operation information of the air conditioner.

The operation information of the air conditioner may include an ON/OFF state of the automatic air conditioning mode, an ON/OFF state of the inside air circulation mode, an ON/OFF state of the outside air circulation mode, an ON/OFF state of the air conditioner, an ON/OFF state of a heating mode, and an ON/OFF state of a cooling mode.

The power distribution control apparatus 130 may transmit a user input inputted through the input device 41 to the terminal 40 so that the user input inputted through the input device 41 is displayed.

The power distribution control apparatus 130 may receive output information of the first heater when the heating mode is in an ON state or when the heating mode is turned on by the automatic air conditioning mode.

The power distribution control apparatus 130 may receive the output information of the first heater in response to the operation of the first heater.

The output information of the first heater may include information on the amount of electricity consumed by the first heater.

The power distribution control apparatus 130 may limit the output of the first heater based on the driving-possible distance information and the output information of the first heater.

The power distribution control apparatus 130 may receive output information of the second load L2, control to limit the electric power to be supplied to the first load based on the received output information of the second load and the output information of the first load, and control to increase the electric power to be supplied to the second load.

The power distribution control apparatus 130 may be configured for controlling output of the second load based on a target heating temperature map for each outside temperature.

The power distribution control apparatus 130 may be configured for controlling the output of the second load based on a comfort level map for each target heating temperature.

The second load L2 may include at least one of at least one of the heating wires and the blowing fan.

The power distribution control apparatus 130 may be configured to determine whether an occupant gets on or off the vehicle based on detection information of the boarding detector 122.

The power distribution control apparatus 130 may be configured to determine whether a driver is in the driver seat, an occupant is in the front seat, and an occupant is in the rear seat.

The power distribution control apparatus 130 is configured to determine the state of the vehicle as the OFF state when the Off command is received through the start button.

The power distribution control apparatus 130 may detect a current flowing into the charge controller 120 and determine as the charging mode when the current is detected.

The power distribution control apparatus 130 may be configured for controlling the operation of the second heater based on the temperature information of the first battery when the vehicle is in the OFF state and in the charging mode.

The OFF state and the ready state, which are the states of the vehicle, may be states classified depending on electric power supply states of the vehicle.

The power distribution control apparatus 130 may also control activation of the automatic air conditioning mode of the air conditioner based on the state of charge information of the first battery, the temperature information of the first battery, and boarding state information of the user.

The electric power distribution control apparatus 130 may include a communication device 131, a processor 132 and a memory 133.

The communication device 131 may include one or more components that enable communication with the components inside the vehicle, and may include, for example, at least one of a short-range communication module, a wired communication module, and a wireless communication module.

The short-range communication module may include various short-range communication modules that transmit and receive signals using a wireless communication network in a short distance such as a Bluetooth module, an infrared communication module, a radio frequency identification (RFID) communication module, a wireless local access network (WLAN) communication module, a Near Field Communication (NFC) module, and a Zigbee communication module.

The wired communication module may include various cable communication modules such as a universal serial bus (USB), a High Definition Multimedia Interface (HDMI), a digital visual interface (DVI), a recommended standard 232 (RS-232), an electric power line communication, and a plain old telephone service (POTS), as well as various wired communication modules such as a Controller Area Network (CAN) communication module, a local area network (LAN) module, a wide area network (WAN) module, and a value added network (VAN) module.

The wired communication module may further include a Local Interconnect Network (LIN).

The wireless communication module, in addition to a Wi-Fi module and a wireless broadband module, may include wireless communication modules that support various wireless communication methods such as a Global System for Mobile communication (GSM), a Code Division Multiple Access (CDMA), a Wideband Code Division Multiple Access (WCDMA), a Universal Mobile Telecommunication System (UMTS), a Time Division Multiple Access (TDMA), Long Term Evolution (LTE), and an ultra-wideband (UWB) module.

The processor 132 may be configured for controlling the operations of the first load and the second load within an air-conditioning allowable electric power range provided by the vehicle platform controller 115 in response to a request of the user when performing the cooling mode and the heating mode. In the instant case, the processor 132 may be configured for controlling operations of a load for air conditioning among the first loads and a load for air conditioning among the second loads.

The load for air conditioning among the first loads may include the first heater and the compressor.

The load for air conditioning among the second loads may include the plurality of heating wires, the blowing fan, and a ventilation fan of the seat ventilator.

The air-conditioning allowable electric power range may be determined by the charge amount of the first battery, electric power to be consumed while driving to the destination, the power consumption, and the driving-possible distance.

The processor 132 is configured to determine a turn-On/Off of an electric power converter (LDC) based on the available electric power and charge amount of the first battery.

The processor 132 limits electricity consumption due to unnecessary acceleration through control of the driving motor when an On command for the Eco mode is received through the input device 41.

For example, even when the driver presses the accelerator pedal, the processor 132 does not transfer an acceleration force corresponding to the pressurization as it is and limits the increase in motor torque.

The processor 132 may be configured for controlling the operation of the driving motor 119 based on a preset torque map when the On command for the Eco mode is received through the input device 41.

When the On command for the Eco mode is received through the input device 41, the processor 132 limits air conditioning by controlling the operation of the first load, and is configured to perform a cooperative air conditioning control by controlling the operation of the second load.

The processor 132 is configured to determine whether the vehicle is in the ready state when the On command for the Eco mode is received through the input device 41, and check the charge amount of the first battery 111 when it is determined that the vehicle is in the ready state.

The processor 132 obtains the driving-possible distance information based on the charge amount of the first battery 111, is configured to determine whether the driving-possible distance exceeds a first reference driving-possible distance based on the obtained driving-possible distance information, and does not perform the power saving mode when it is determined that the driving-possible distance exceeds the first reference driving-possible distance.

When it is determined that the driving-possible distance exceeds the first reference driving-possible distance, the processor 132 may be configured for controlling driving in the Eco mode by controlling the operation of the driving motor 119 based on the preset torque map.

As illustrated in FIG. 5, the processor 132 is configured to determine whether the driving-possible distance is equal to or longer than a second reference driving-possible distance when it is determined that the driving-possible distance is equal to or shorter than the first reference driving-possible distance, is configured to determine that the drive mode enters a first power saving mode when it is determined that the driving-possible distance is longer than or equal to the second reference driving-possible distance, is configured to determine whether the driving-possible distance is longer than or equal to a third reference driving-possible distance when it is determined that the driving-possible distance is shorter than the second reference driving-possible distance, and is configured to determine that the drive mode enters a second power saving mode when it is determined that the driving-possible distance is equal to or longer than the third reference driving-possible distance.

The processor 132 turns off a cooperative control with the second load when it is determined that the driving-possible distance is shorter than the third reference driving-possible distance. That is, when it is determined that the driving-possible distance is shorter than the third reference driving-possible distance, the processor 132 may turn off the cooling mode and the heating mode and turn off all operations of the plurality of heating wires.

That is, the processor 132 may turn off the first heater or compressor and turn off all of the plurality of heating wires w % ben the driving-possible distance is shorter than the third reference driving-possible distance.

The driving-possible distance information may be information transmitted from the vehicle platform controller.

The first reference driving-possible distance may be about 150 km, the second reference driving-possible distance may be about 100 km, and the third reference driving-possible distance may be about 40 km.

The processor 132 is configured to determine whether the first load is in operation and is configured to perform an air conditioning control for each power saving mode when it is determined that the first load is in operation.

The processor 132 is configured to determine whether the automatic air conditioning mode is in an ON state when the first load is in a stopped state, and is configured to perform the air conditioning control for each power saving mode when it is determined that the automatic air conditioning mode is in the ON state. Herein, the first load may be the first heater.

The automatic air conditioning mode may be an automatic air conditioning mode for heating.

When an automatic air conditioning switch is in an ON state, the processor 132 may be configured to determine that the automatic air conditioning mode is in the ON state.

When performing the air conditioning control for each power saving mode, the processor 132 may be configured for controlling the output of the first load to decrease by a first output amount when it is determined that the drive mode is in a state of entering the first power saving mode, and may be configured for controlling the output of the second load to decrease by a second output amount when it is determined that the drive mode is in a state of entering the second power saving mode.

The second output amount may be a lower output amount than the first output amount.

The controlling of the output of the first load to decrease by the first output amount includes adjusting the target heating temperature as low as a temperature between minus 0.5 Celsius and minus 3 degrees Celsius and controlling the operation of the first load based on the adjusted heating temperature.

The controlling of the output of the first load to decrease by the first output amount includes the first load based on the adjusted heating temperature matched for each target heating temperature for the first power saving mode.

The controlling of the output of the first load to decrease by the second output amount includes adjusting the target heating temperature as low as a temperature between minus 0.5 Celsius and minus 5 degrees Celsius and controlling the operation of the first load based on the adjusted heating temperature.

The controlling of the output of the first load to decrease by the second output amount includes the first load based on the adjusted heating temperature matched for each target heating temperature for the second power saving mode.

The processor 132 may release the power saving mode when a user input for air conditioning control is received through the input device 41.

The user input for air conditioning control may include the ON/OFF command for the outside air circulation mode and the inside air circulation mode, the ON/OFF command for the automatic heating wire mode and the automatic air conditioning mode, the ON/OFF command for at least one of the heating wires, a command for adjusting the temperature level of at least one of the heating wires, and a command for adjusting the target inside temperature.

When the first load is in the stopped state or the automatic air conditioning mode is in the OFF state, the processor 132 may release the power saving mode and perform an air conditioning control in response to a user input.

The air conditioning control in response to the user input may include controlling the operation of the first load based on the target inside temperature set by the user or controlling the operation of the first load based on a preset target inside temperature.

The processor 132 may be configured to determine whether an On command for an concentrated driver seat air conditioning control mode is received when the drive mode is the Eco mode and the vehicle is in the ready state, control the operation of the driver seat heating wire or the driver seat ventilator when it is determine that the On command for the concentrated driver seat air conditioning control mode is received, and control to cut off the electric power to be supplied to the remaining seat heating wires or the remaining seat ventilators.

The processor 132 may be configured for controlling to stop the operation of the front occupant seat and rear seat heating wires or seat ventilators when the drive mode is the Eco mode, and the vehicle is in the ready state and the concentrated driver seat air conditioning control mode.

The processor 132 may be configured for controlling the operation of the second load for air conditioning cooperation when performing the first power saving mode or the second power saving mode.

The processor 132 is configured to determine whether a plurality of seat heating wires is in operation during cooperative air conditioning control, checks the inside temperature detected by the inside temperature sensor when it is determined that at least one of the plurality of seat heating wires is in operation, and turns off the operations of the front occupant seat heating wire and the rear seat heating wire when it is determined that the checked inside temperature is higher than a reference temperature.

When it is determined that the checked inside temperature is lower than the reference temperature during cooperative air conditioning control, the processor 132 may be configured for controlling a level of the plurality of heating wires and the ON/OFF of the plurality of heating wires based on a temperature level map of the seat heating wires for each outside temperature or a temperature level map of the seat heating wires for each comfort level.

The processor 132 may be configured to determine whether an On command for an interlocking mode performing interlocking between the concentrated driver seat air conditioning mode and the heating wires is received when it is determined that the plurality of seat heating wires is in the stopped state during cooperative air conditioning control, and automatically control the operations of the front occupant seat heating wire, the rear seat heating wire, and the steering heating wire when it is determined that the On command for an interlocking mode is received.

The processor 132 may perform an automatic heating wire control for each outside temperature or an automatic heating wire control for each comfort level when it is determined that an Off command for an interlocking mode is received.

When it is determined that the checked inside temperature is lower than the reference temperature, the processor 132 may perform an automatic heating wire control based on the temperature level map of the seat heating wires for each outside temperature or the temperature level map of the seat heating wires for each comfort level.

The processor 132 may be configured for controlling the display device 42 to output information on entry of the power saving mode, and control the display device 42 to output information on release of the power saving mode.

The processor 132 changes to a state configured for receiving the Off command for the automatic air conditioning mode when the On command for the automatic air conditioning mode is received. That is, the processor 132 may output text indicating ‘off’ through the display device.

During cooperative air conditioning control, the processor 132 may be configured for controlling to close the window glass, control to close the sunroof, and control to turn off the outside air circulation mode.

The processor 132 may turn on the outside air circulation mode when the preset time elapses in the case in which the outside air circulation mode is turned off.

The processor 132 may turn on the outside air circulation mode when the contamination degree of air inside the vehicle is equal to or greater than the reference contamination degree in the case in which the outside air circulation mode is turned off.

The processor 132 may be configured to determine as an Off mode when an Off command is received from the start button 36.

The processor 132 is configured to determine whether the vehicle is in the charging mode based on current information received from the charge controller 120, checks the temperature of the first battery detected by the temperature sensor when it is determined that the vehicle is in an automatic mode, checks the charge amount of the first battery when it is determined that the temperature of the first battery is equal to or lower than a first reference temperature, and is configured to control preheating of the first battery by operating the second heater when it is determined that the charge amount of the first battery is less than a reference charge amount.

The processor 132 may check the temperature of the first battery while the first battery is preheating, determine whether the user is on board when it is determined that the checked temperature is equal to or greater than a second reference temperature, and control activation of the automatic air conditioning mode when it is determined that the user is on board.

The processor 132 may be configured to determine whether the user gets on or off based on communication connection information with a pre-registered terminal of the user.

The processor 132 may also determine whether the user gets on or off based on image information of a camera provided in the vehicle.

When a boarding detector is provided on the seat or seat belt, the processor 132 is configured to determine that the user is in a boarding state based on detection information of the boarding detector provided on the seat or the seat belt, and in the instant case, the processor 132 may ignore a door open signal and a door close signal to determine whether the user is on board.

Accordingly, the processor 132 may be configured to determine the boarding state and a get-Off state of the user based on the detection information of the boarding detector 122.

The processor 132 may be implemented as a memory for storing an algorithm for controlling the operations of the components in the vehicle or data for a program reproducing the algorithm and a processor for performing the above-described operations using data stored in the memory. In the instant case, the memory and the processor may be implemented as separate chips or may be implemented as a single chip.

The memory 133 may store the target heating temperature map for each outside temperature and the temperature level map of the seat heating wires for each outside temperature.

The memory 133 may store the temperature level map of the seat heating wires for each comfort level.

The memory 133 may store the comfort level map for each target heating temperature.

The memory 133 may store a torque map of a driving motor corresponding to the Eco mode.

The memory 133 stores a target heating temperature map corresponding to the first power saving mode and a target heating temperature map corresponding to the second power saving mode.

The target heating temperature map corresponding to the first power saving mode may include a temperature adjusted between minus 0.5 degrees Celsius and minus 3 degrees Celsius from the target heating temperature.

The target heating temperature map corresponding to the second power saving mode may include a temperature adjusted between minus 0.5 degrees Celsius and minus 5 degrees Celsius from the target heating temperature.

The memory 133 stores information related to the reference charging amount, the first reference temperature, and the second reference temperature for controlling preheating of the first battery. Herein, the reference charging amount may be about 50% of SCO.

The memory 133 stores information related to the first reference driving-possible distance, the second reference driving-possible distance, and the third reference driving-possible distance.

The first reference driving-possible distance may be about 150 km, and the second reference driving-possible distance may be about 100 km, which is shorter than the first reference driving-possible distance.

The third reference driving-possible distance may be about 40 km, which is shorter than the second reference driving-possible distance.

The memory 133 stores seat heating wire information in which seat heating wire identification information is matched for each seat.

The memory 133 may store information on electric power consumed by each heating wire, electric power consumed by the blowing fan, electric power consumed by a basic load, and electric power consumed by the first and second heaters.

Herein, the consumed electric power may be rated electric power consumed, average consumed electric power, or maximum consumed electric power.

The memory 133 may store information on electric power consumed by opening and closing members of the window glasses and electric power consumed by an opening and closing member of the sunroof.

The memory 133 may be implemented as at least one of a non-volatile memory device such as a cache, a read only memory (ROM), a programmable ROM (PROM), an erasable programmable ROM (EPROM), an electrically erasable programmable ROM (EEPROM), and a flash memory, a volatile memory device such as a random access memory (RAM), and a storage medium such as a Hard Disk Drive (HDD) and a CD-ROM, but is limited thereto.

Each of the components illustrated in FIG. 2, FIG. 3 and FIG. 4 means a software component and/or a hardware component such as a field-programmable gate array (FPGA) and an application specific integrated circuit (ASIC).

At least one component may be added or deleted depending on the performance of the components of the electric power controller illustrated in FIG. 2, FIG. 3 and FIG. 4. It will be easily understood by those skilled in the art that the mutual positions of the components may be changed depending on the performance or structure of the system.

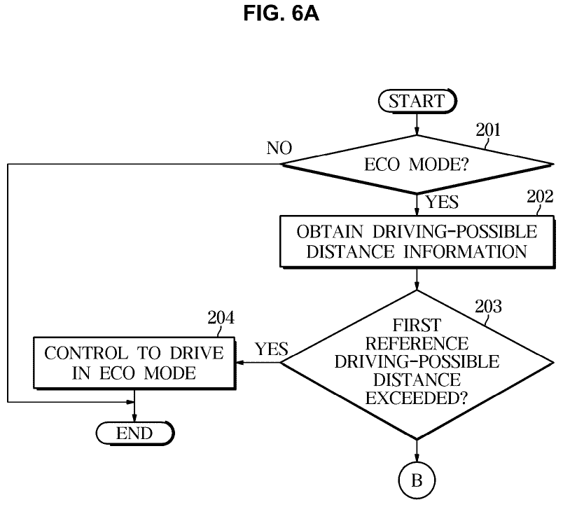

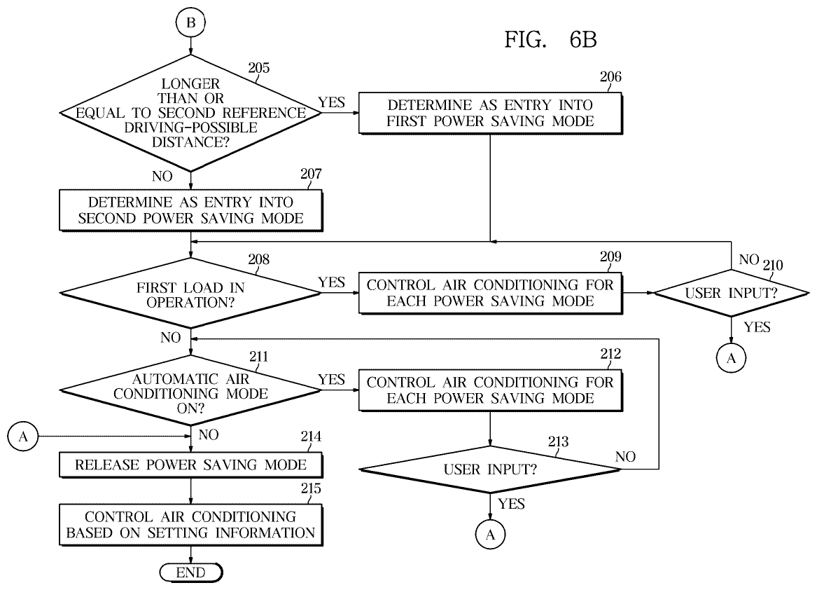

FIG. 6A and FIG. 6B are a control flowchart of the vehicle according to an exemplary embodiment of the present disclosure.

When an On command for the Eco mode is received through the input device 41, the vehicle is configured to determine that an intention of the user for the drive mode is the Eco mode.

The vehicle is configured to determine whether the vehicle is in the ready state when it is determined that the drive mode is the Eco mode (201), and checks the charge amount of the first battery when it is determined that the vehicle is in the ready state.

The vehicle obtains the driving-possible distance information based on the charge amount of the first battery and the pre-stored power consumption information (202).

The vehicle may be configured for controlling entry into the power saving mode or control non-execution of the power saving mode based on the obtained driving-possible distance information.

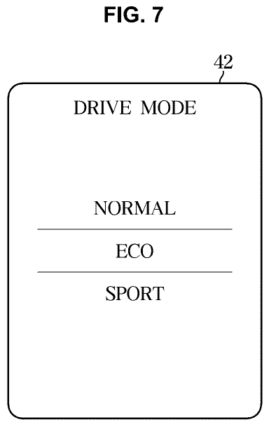

As illustrated in FIG. 7, the vehicle may display the drive mode through the terminal 40.

The vehicle is configured to determine whether the driving-possible distance exceeds the first reference driving-possible distance based on the obtained driving-possible distance information (203), and does not execute the power saving mode when it is determined that the driving-possible distance exceeds the first reference driving-possible distance.

The vehicle may be configured for controlling the operation of the driving motor 119 based on the preset torque map when the power saving mode is not executed. That is, the vehicle may be configured for controlling driving in the Eco mode (204).

Before the drive mode enters the power saving mode, the vehicle is configured to determine a power saving mode to enter among a plurality of power saving modes.

That is, the vehicle is configured to determine whether the driving-possible distance is equal to or longer than the second reference driving-possible distance (205) when it is determined that the driving-possible distance is equal to or shorter than the first reference driving-possible distance, is configured to determine that the drive mode has entered the first power saving mode when it is determined that the driving-possible distance is longer than or equal to the second reference driving-possible distance (206), and is configured to determine that the drive mode has entered the second power saving mode when it is determined that the driving-possible distance is shorter than the second reference driving-possible distance (207).

The vehicle may also determine whether the driving-possible distance is shorter than the third reference driving-possible distance when it is determined that the driving-possible distance is shorter than the second reference driving-possible distance, and determine that the drive mode has entered the second power saving mode when it is determined that the driving-possible distance is longer than or equal to the third reference driving-possible distance.

The vehicle may also determine that the drive mode has entered the third power saving mode when it is determined that the driving-possible distance is shorter than the third reference driving-possible distance.

The vehicle is configured to determine whether the first load is in operation when the drive mode has entered the first power saving mode or the second power saving mode (208), and is configured to perform air conditioning control for each power saving mode when it is determined that the first load is in operation (209).

Herein, the first load may be the first heater in the heating mode, and may be the compressor in the cooling mode.

The vehicle is configured to determine whether a user input for air conditioning control is received through the input device 41 while air conditioning control for each power saving mode is performed in response to the operation of the first load (210), releases the power saving mode (214) and checks setting information set by the user in response to the user input when it is determined that the user input is received, and is configured to perform the air conditioning control based on the checked setting information (215).

The vehicle is configured to determine whether the automatic air conditioning mode is in the ON state when it is determined that the first load is in the stopped state (211), and is configured to perform air conditioning control for each power saving mode when it is determined that the automatic air conditioning mode is in the ON state (212).

In the case of performing air conditioning control for each power saving mode, the vehicle may adjust the target inside temperature based on the target inside temperature and first temperature control information when the power saving mode is the first power saving mode, and control the output of the first load based on the adjusted target inside temperature.

In the case of performing air conditioning control for each power saving mode, the vehicle may adjust the target inside temperature based on the target inside temperature and second temperature control information when the power saving mode is the second power saving mode, and control the output of the first load based on the adjusted target inside temperature.

In the heating mode, the target inside temperature may be a target inside heating temperature.

In the cooling mode, the target inside temperature may be a target inside cooling temperature.

In the heating mode, an adjustable temperature in the first temperature control information may be higher than an adjustable temperature in the second temperature control information.

In the cooling mode, an adjustable temperature in the first temperature control information may be lower than an adjustable temperature in the second temperature control information.

In the heating mode, the first temperature control information may include a temperature between minus 0.5 degrees Celsius and minus 3 degrees Celsius, and the second temperature control information may include a temperature between minus 0.5 degrees Celsius and minus 5 degrees Celsius.

Adjusted temperatures for each power saving mode may be matched and stored for each target inside temperature.

In the case of performing air conditioning control for each power saving mode, the vehicle may decrease the output of the first load by a first output amount when it is determined that the drive mode is in the state of entering the first power saving mode, and decrease the output of the first load by a second output amount when it is determined that the drive mode is in the state of entering the second power saving mode.

The second output amount may be a lower output amount than the first output amount.

That is, the electric power consumed by the first load may be reduced for each power saving mode, but may be reduced to different magnitudes.

In a case in which the first and second power saving modes are executed, the vehicle may turn off all the heating wires when it is determined that the inside temperature is higher than a preset temperature.

When the first and second power saving modes are executed, the vehicle may close the window glasses and the sunroof and turn off the outside air circulation mode.

While the first and second power saving modes are executed, the vehicle may turn on the seat heating wires when the inside temperature decreases below a predetermined temperature, and turn off the seat heating wires when the set time elapses.

While the first and second power saving modes are executed, the vehicle may check whether an occupant is present for each seat when the inside temperature decreases below the predetermined temperature, and may turn on only the seat heating wire of the seat in which the occupant is present.

While the first and second power saving modes are executed, the vehicle may turn on the steering heating wire when the inside temperature drops below the predetermined temperature, and turn off the steering heating wire when the set time elapses.

While the concentrated driver seat air conditioning mode is executed, the vehicle operates only blowing fans of air outlets close to the driver seat when the drive mode enters the first and second power saving modes, and may operate the steering heating wire and the driver seat heating wire.

While air conditioning control for each power saving mode is performed in response to the turn-on of the automatic air conditioning mode, the vehicle is configured to determine whether a user input for air conditioning control is received through the input device 41 (213), releases the power saving mode (214) and checks the setting information set by the user in response to the user input when it is determined that the user input is received, and is configured to perform air conditioning control based on the checked setting information (215).

The user input for air conditioning control may include the outside air circulation mode, the ON/OFF command for the inside air circulation mode, an automatic heating mode, the ON/OFF command for the automatic air conditioning mode, the ON/OFF command for at least one of the heating wires, a temperature level control command for at least one of the heating wires, and a target inside temperature control command.

When the power saving mode is released, the vehicle may be configured for controlling the operation of the first load L1 based on the target inside temperature set by the user, or may be configured for controlling the operation of the first load L1 based on the preset target inside temperature.

The vehicle may be configured to determine that the automatic air conditioning mode is in the ON state when the automatic air conditioning switch is in the ON state, and may be configured to determine that the automatic air conditioning mode is in the OFF state when the automatic air conditioning switch is in an OFF state.

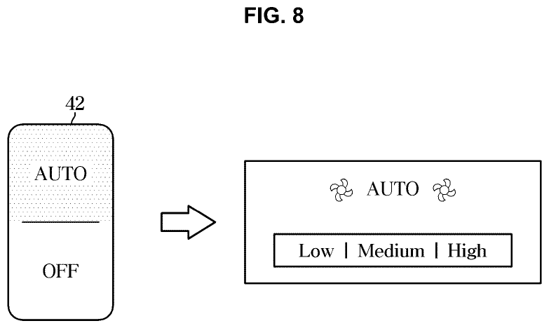

As illustrated in FIG. 8, the vehicle may display that the automatic air conditioning mode is selected through the terminal 40, and may also display an off text indicating ‘off’ to receive the Off command for the automatic air conditioning mode.

The vehicle may display information on an air-blowing amount which may be selected by the user through the terminal 40 while the automatic air conditioning mode are executed.

The vehicle may be configured to determine whether the On command for the concentrated driver seat air conditioning mode is received when the drive mode is the Eco mode and the vehicle is in the ready state, control the operation of the driver seat heating wire or the driver seat ventilator when it is determined that the On command for the concentrated driver seat air conditioning mode is received, and cut off electric power to be supplied to the seat heating wires or the seat ventilator of the remaining seats.

That is, when the drive mode is the Eco mode, and the vehicle is in the ready state and the concentrated driver seat air conditioning mode, the vehicle may be configured for controlling to stop the operation of the seat heating wires or the seat ventilators for the front occupant seat and the rear seat.

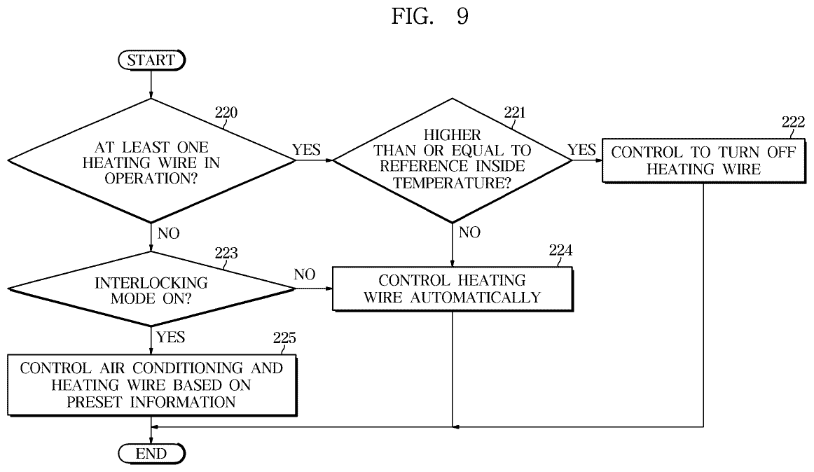

FIG. 9 is a flowchart of a cooperative control during execution of the power saving mode of the vehicle according to an exemplary embodiment of the present disclosure.

When the drive mode is the Eco mode, the vehicle is in the ready state, and the driving-possible distance is equal to or longer than the third reference driving-possible distance and shorter than the first reference driving-possible distance, the vehicle may limit air conditioning by controlling the operation of the first load, and perform cooperative control for air conditioning by controlling the operation of the second load.

That is, when the first and second power saving modes are executed, the vehicle may be configured for controlling the second load to cooperate with air conditioning.

When the first and second power saving modes are executed, the vehicle is configured to determine whether at least one of the heating wires is in operation (220). Herein, the at least one heating wire may be at least one of the driver seat heating wire, the occupant seat heating wire, the rear seat heating wire, the glass heating wire, and the steering heating wire.

When it is determined that the at least one heating wire is in operation, the vehicle checks the inside temperature detected by the inside temperature sensor, and is configured to determine whether the checked inside temperature is equal to or greater than the reference inside temperature.

When the checked inside temperature is equal to or greater than the reference inside temperature, the vehicle may be configured for controlling to turn off the at least one heating wire (222). In the instant case, the vehicle may perform air conditioning control by decreasing the output of the first load for each power saving mode.

When it is determined that the checked inside temperature is lower than the reference inside temperature, the vehicle automatically controls the operation of at least one of the heating wires. In the instant case, the vehicle may automatically control the operation of the at least one heating wire based on the temperature level map of the seat heating wires for each outside temperature.

The vehicle may also automatically control the operation of the at least one heating wire based on the temperature level map of the seat heating wires for each comfort level.

When it is determined that at least one of the heating wires is in the OFF state, the vehicle is configured to determine whether the interlocking mode is turned on (223). Herein, the interlocking mode may be a mode in which the concentrated driver seat air conditioning mode and the at least one of the heating wires are interlocked.

When it is determined that the interlocking mode is turned off, the vehicle is automatically configured to control the operation of at least one of the heating wires (224). In the instant case, the vehicle may automatically control the operation of the at least one heating wire based on the temperature level map of the seat heating wires for each outside temperature.

When it is determined that the interlocking mode is turned on, the vehicle may be configured for controlling air conditioning and the heating wires based on preset information (225). That is, the vehicle may be configured for controlling the operations of the seat heating wires at a temperature level selected by the user or a preset temperature level in response to the automatic heating mode of the seat heating wires, and control the operation of the steering heating wire at a temperature level selected by the user or at a preset temperature level in response to the automatic heating wire mode of the steering heating wire.

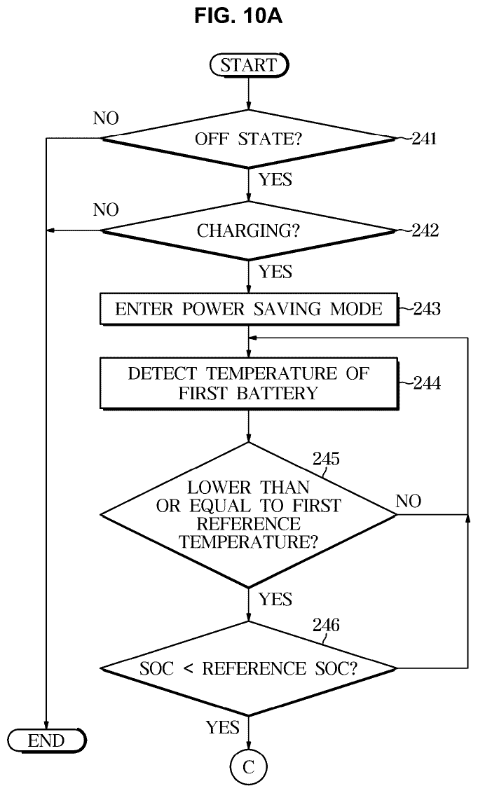

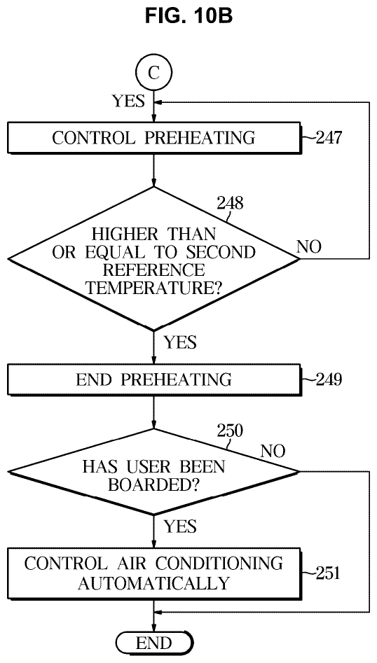

FIG. 10A and FIG. 10B are a control flowchart in a charging mode of the vehicle according to an exemplary embodiment of the present disclosure.

When the Off command is received from the start button 36, the vehicle may determine the state of the vehicle as the OFF state.

When it is determined that the vehicle is in the OFF state (241), the vehicle detects the current of the first battery and is configured to determine whether the vehicle is in the charging mode based on the detected current of the first battery.

When it is determined that the first battery is in a state of being charged in response to the charging mode (242), the vehicle enters the power saving mode (243).

The vehicle detects the temperature of the first battery using the temperature sensor while the first battery is being charged (244).

The vehicle is configured to determine whether the detected temperature of the first battery is equal to or lower than the first reference temperature (245), checks the charge amount (SOC) of the first battery when it is determined that the temperature of the first battery is equal to or less than the first reference temperature, is configured to determine whether the checked charge amount of the first battery is less than the reference charge amount (246), and is configured to control the preheating of the first battery by controlling the operation of the second heater when it is determined that the charge amount of the first battery is less than the reference charge amount (247).

The vehicle detects the temperature of the first battery through the temperature sensor during the preheating of the first battery, is configured to determine whether the detected temperature of the first battery is equal to or greater than the second reference temperature (248), and ends the preheating of the first battery when the vehicle determines that the temperature of the first battery is equal to or greater than the second reference temperature (249).

The vehicle may be configured to determine whether the user has boarded the vehicle during charging (250) and control activation of the automatic air conditioning mode when it is determined that the user has boarded the vehicle (251).

The vehicle may be configured for controlling preheating of the first battery based on a departure time set by the user and a current time while the first battery is being charged.

The vehicle may check a charging efficiency of the first battery while the first battery is being charged and control preheating of the first battery when it is determined that the checked charging efficiency is less than or equal to a reference charging efficiency.

As is apparent from the above, a vehicle according to an exemplary embodiment of the present disclosure can provide a comfortable internal and safely and rapidly arrive at a destination without a separate charging action by optimally controlling an air conditioning function depending on a driving-possible distance when the vehicle is in an Eco mode and is in a ready state. That is, the vehicle according to an exemplary embodiment of the present disclosure can reduce anxiety of a user by securing the driving-possible distance. The vehicle according to an exemplary embodiment of the present disclosure can improve the driving-possible distance in winter.

The vehicle according to an exemplary embodiment of the present disclosure can minimize inconvenience of the user in charging while driving to the destination. That is, the present disclosure can improve satisfaction of users using eco-friendly vehicles.

As the vehicle according to an exemplary embodiment of the present disclosure solves the inconvenience of eco-friendly vehicles, sales volume and usage of eco-friendly vehicles may be increased, reducing environmental contamination caused by vehicles.

The vehicle according to an exemplary embodiment of the present disclosure can stabilize the overall electric power state of the vehicle and improve a fuel economy (i.e., electricity economy) efficiency of the vehicle.

The vehicle according to an exemplary embodiment of the present disclosure can improve the marketability of the vehicle, furthermore, increase user satisfaction, improve user reliability, and secure product competitiveness.

The disclosed exemplary embodiments of the present disclosure may be implemented in a form of a recording medium storing instructions executable by a computer. The instructions may be stored in the form of program code, and when executed by a processor, a program module may be generated to perform the operations of the disclosed exemplary embodiments of the present disclosure. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A power distribution control apparatus comprising:
a communication device configured to communicate with a battery monitoring system and an input device; and
a processor communicatively connected to the communication device, configured to, when the processor receives an On command for an Eco mode through the input device and the processor concludes that a vehicle is in a ready state, obtain a driving-possible distance based on a state of charge (SOC) value of a first battery received through the battery monitoring system and control a power saving mode of the vehicle based on the obtained driving-possible distance,
wherein the processor, in response to the control of the power saving mode, is configured to control an output of a first load in the vehicle so that an amount of electricity to be supplied to the first load from the first battery is reduced.

2. The power distribution control apparatus of claim 1, wherein the processor is further configured to determine whether the vehicle is in the ready state based on an operating state of a driving motor connected to a wheel in the vehicle.

3. The power distribution control apparatus of claim 1, wherein the processor is further configured to release the power saving mode when an ON/OFF command for automatic air conditioning, an ON/OFF command for at least one heating wire, an ON/OFF command for an air circulation mode, or information on a target inside temperature is received through the input device.

4. The power distribution control apparatus of claim 1, wherein the processor is further configured to release the power saving mode when the obtained driving-possible distance exceeds a first reference driving-possible distance.

5. The power distribution control apparatus of claim 4,
wherein the power saving mode includes a first power saving mode and a second power saving mode, and
wherein the processor is configured to:
determine whether the obtained driving-possible distance is shorter than a second reference driving-possible distance when the processor concludes that the obtained driving-possible distance is shorter than or equal to the first reference driving-possible distance,
determine that a drive mode enters the first power saving mode when the processor concludes that the obtained driving-possible distance is shorter than the second reference driving-possible distance, and
determine that the drive mode enters the second power saving mode when the processor concludes that the obtained driving-possible distance is longer than or equal to the second reference driving-possible distance, and
wherein the first reference driving-possible distance is longer than the second reference driving-possible distance.

6. The power distribution control apparatus of claim 5, wherein the processor is configured to:
control the output of the first load to a first output amount when the drive mode enters the first power saving mode, and
control the output of the first load to a second output amount lower than the first output amount when the drive mode enters the second power saving mode.

7. The power distribution control apparatus of claim 1,
wherein the processor, when controlling the power saving mode, is configured to stop an operation of the first load and to control an operation of a second load using electric power of a second battery, and
wherein a voltage of the second battery is lower than a voltage of the first battery.

8. The power distribution control apparatus of claim 7,
wherein the processor is further configured to control to stop the operations of the first and second loads when the obtained driving-possible distance is shorter than a third reference driving-possible distance, and
wherein the third reference driving-possible distance is shorter than the second reference driving-possible distance.

9. The power distribution control apparatus of claim 8,
wherein the first load includes a driving motor, a heater for heating, and a heater for preheating of the first battery, and
wherein the second load includes at least one heating wire and a blowing fan of an air conditioner.

10. The power distribution control apparatus of claim 1, wherein the processor is further configured to control an operation of the first load based on a temperature and the SOC value of the first battery when the vehicle is in an OFF state and in a charging mode.

11. A vehicle comprising:
an input device;
a first battery configured to supply electric power to a driving motor and a first load;
a battery monitoring system configured to monitor a state of charge (SOC) value of the first battery; and
a power distribution control apparatus including a processor and configured to determine whether the vehicle is in a ready state based on an operating state of the driving motor when an On command for an Eco mode is received through the input device, obtain a driving-possible distance based on the SOC value of the first battery when the power distribution control apparatus concludes that the vehicle is in the ready state, and control a power saving mode of the vehicle based on the obtained driving-possible distance,
wherein the power saving mode is a mode in which electric power to be supplied to the first load is limited.

12. The vehicle of claim 11, wherein the power distribution control apparatus is further configured to release the power saving mode when an ON/OFF command for automatic air conditioning, an ON/OFF command for at least one heating wire, an ON/OFF command for an air circulation mode, or information on a target inside temperature is received through the input device.

13. The vehicle of claim 11, wherein the power distribution control apparatus is further configured to release the power saving mode when the obtained driving-possible distance exceeds a first reference driving-possible distance.

14. The vehicle of claim 13,
wherein the power saving mode includes a first power saving mode and a second power saving mode, and
wherein the power distribution control apparatus is further configured to:
determine whether the obtained driving-possible distance is shorter than a second reference driving-possible distance when the processor concludes that the obtained driving-possible distance is shorter than or equal to the first reference driving-possible distance, and
determine that a drive mode enters the first power saving mode when the processor concludes that the obtained driving-possible distance is shorter than the second reference driving-possible distance, and
determine that the drive mode enters the second power saving mode when the processor concludes that the obtained driving-possible distance is longer than or equal to the second reference driving-possible distance, and
wherein the first reference driving-possible distance is longer than the second reference driving-possible distance.

15. The vehicle of claim 14, wherein the power distribution control apparatus is further configured to:
control an output of the first load to a first output amount when the drive mode enters the first power saving mode, and
control the output of the first load to a second output amount lower than the first output amount when the drive mode enters the second power saving mode.

16. The vehicle of claim 11, further including:
an electric power converter provided to convert a voltage of electric power output from the first battery into a voltage of a different magnitude; and
a second battery provided to perform charging using the voltage converted by the electric power converter and to supply electric power to a second load,
wherein the power distribution control apparatus, when controlling the power saving mode, stops an operation of the first load and controls an operation of the second load using electric power of the second battery.

17. The vehicle of claim 16, wherein the power distribution control apparatus is further configured to control to stop the operations of the first and second loads when the obtained driving-possible distance is shorter than a reference driving-possible distance, and controls an operation of the driving motor based on a preset torque map of the driving motor.

18. The vehicle of claim 17,
wherein the first load includes the driving motor, a heater for heating, and a heater for preheating of the first battery, and
wherein the second load includes at least one heating wire and a blowing fan of an air conditioner.

19. The vehicle of claim 18,
wherein the battery monitoring system includes a temperature sensor provided to detect a temperature of the first battery, and
wherein the power distribution control apparatus is further configured to control the operation of the first load based on the temperature of the first battery detected by the temperature sensor and the SOC value of the first battery when the vehicle is in an OFF state and in a charging mode.

20. The vehicle of claim 19, further including
a boarding detector provided to detect boarding of a user in the vehicle,
wherein the power distribution control apparatus is further configured to activate an automatic air conditioning mode based on the temperature of the first battery and boarding information detected by the boarding detector.
